(19) United States
(12) Patent Application Publication
(10) Pub. No.: US 2016/0370912 A1
(43) Pub. Date: Dec. 22, 2016

(54) MULTIPLE MATRIX DIFFERENTIAL TOUCH SENSE

(71) Applicant: Microsoft Technology Licensing, LLC, Redmond, WA (US)

(72) Inventors: Tianzhu Qiao, Portland, OR (US); Jonathan Westhues, Portland, OR (US)

(21) Appl. No.: 14/746,640

(22) Filed: Jun. 22, 2015

(51) Int. Cl. G06F 3/041; G06F 3/0354; G06F 3/044

(52) U.S. Cl. CPC G06F 3/0416; G06F 3/044; G06F 3/03545; G06F 2203/04106

(57) ABSTRACT

A touch-sensing system for use with a display system is provided herein. The touch-sensing system includes: (1) a first touch-sensor matrix having rows and columns and situated planarly relative to the display system; (2) a second touch-sensor matrix having rows and columns and situated planarly relative to the display system; and (3) a drive subsystem coupled to the rows of the first touch-sensor matrix and to the rows of the second touch-sensor matrix. Within each of a plurality of touch-sense frames, the drive subsystem serially drives the rows of each of the touch-sensor matrices in a differential drive manner, in which a first drive signal is used for the rows of the first touch-sensor matrix and a second drive signal, different from the first, is used for the rows of the second touch-sensor matrix.

### BACKGROUND

Touch-sensing systems, such as capacitive touch displays, have been developed to recognize and act upon finger touch and stylus touch inputs applied by users. Certain touch-sensing systems drive row electrodes in a touch-sensor matrix positioned over, or at some depth within, a display (e.g., an LCD stack). A capacitance signal, which can be affected by electrode drive signals, noise and the presence of finger/stylus touches, is then measured in receive circuitry of the column electrodes. Received signals may be correlated against expected signals to identify and locate touch events.

Touch-sensing products are likely to evolve to a point where it will be desirable to employ multiple distinct touch-sensor matrices. Such a system will may involve a number of design and operational challenges. Potential hurdles include coordinating sensor activity; missing or duplicating touch inputs as a result of motion near seams between matrices; decreased signal-to-noise ratio; challenges with stylus performance near seams; pressures to decrease touch-frame frequency; etc.

### BRIEF DESCRIPTION OF THE DRAWINGS

FIG. 1 depicts an example touch-sensing system.

FIG. 2 further depicts the touch-sensing system of FIG. 1 and some associated subsystems.

FIG. 3 depicts an example touch-sensor matrix that may form part of the system of FIG. 1.

FIG. 4 depicts an example active stylus that may be used with the system of FIG. 1.

FIG. 5 depicts example drive schemes that may be used with multiple touch-sensor matrices.

FIG. 6 depicts an example touch-sensing method.

FIG. 7 depicts an example computing system, one or more aspects of which may be used to implement the systems and methods of FIGS. 1-6.

### DETAILED DESCRIPTION

A touch-sensing system having multiple touch-sensor matrices for sensing touch inputs is described herein. The touch-sensing system includes a display system associated with the touch-sensor matrices. The touch-sensor matrices can lie on top of, or at some depth within, the display system, which can include one or more LCD stacks or other display devices. The touch-sensor matrices may be situated adjacent to one another, typically with a small seam or joint area between side edges of the matrices.

In many examples, rows near the seam between two matrices are driven close in time to one another. For example, for an upper matrix positioned directly above a lower matrix, the bottom ten rows (or any other number of rows) of the upper matrix and the top ten rows of the lower matrix might be driven during the same short interval. As described below, this may reduce the risk of missed or duplicated inputs within a touch frame, and can reduce an active stylus's vulnerability to time-varying noise. In more specific implementations, near-seam rows can be scanned close in time using opposite direction scan patterns for adjacent matrices. In the above example, rows in the upper matrix could be scanned bottom-to-top and rows in the lower matrix could be scanned top-to-bottom.

In many examples, the rows in the different touch-sensor matrices are operated in a differential drive manner, such that the drive signal for the rows on a first matrix is different than the drive signal for the rows on a second, adjacent matrix. In this case, each matrix has column receive circuitry that is specifically tuned to run correlations accounting for the particular drive signal being used for that matrix. Differential drive can lead to improved operation of both a finger touch and an active stylus used in connection with the different matrices. Since differential drive may reduce the cross interference between the adjacent matrices, the signal to noise ratio for finger touch may be improved. The active stylus includes receive circuitry configured for each of the differential drive signals being employed. Specifically, the stylus includes: (1) receive circuitry tuned to run correlations based on the drive signal used to drive the rows in the first matrix; and (2) receive circuitry tuned to run correlations based on the drive signal used to drive the rows in the second matrix. Depending on the specific implementation, this differential drive scheme can improve stylus performance without reducing the time efficiency of the touch frames.

The use of “touch” herein may refer both to finger/hand touches, and to touches of an active or passive stylus. It will also be appreciated the row-drive techniques discussed herein are also applicable to near-touch or hover inputs, in which a finger, stylus, etc. is spaced from an input surface (e.g., by a few millimeters or farther).

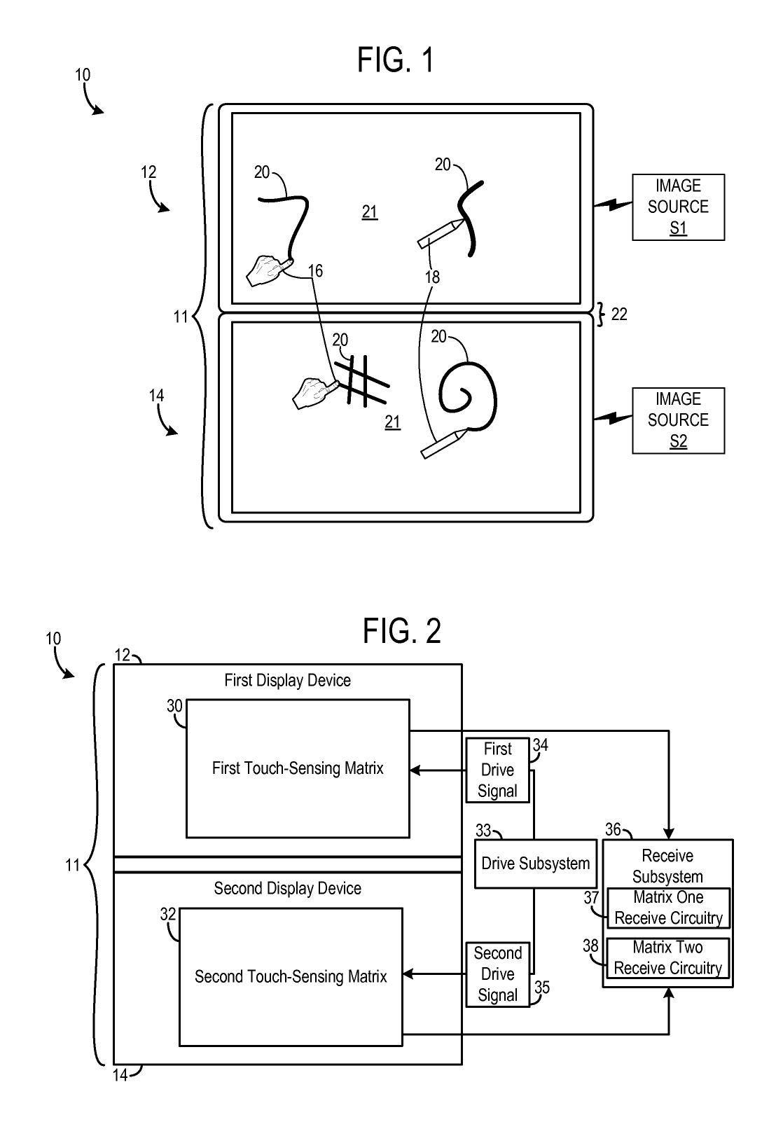

FIG. 1 shows an example touch-sensing system 10, including two or more touch-sensor matrices (not shown) on, or at some depth within, a display system 11. In the depicted example, the display system 11 includes a first display device 12 adjacent to a second display device 14. In such an example, each display device may have an associated touch-sensor matrix. In other examples, the display system may include a single display device spanning the two or more touch-sensor matrices. In the depicted example, each of the display devices 12 and 14 may have a diagonal dimension of greater than 30 inches. In some particularly large-format embodiments, this diagonal dimension can be 55 inches or greater. These are but examples; one or more display devices may be used in connection with two or more touch-sensor matrices in a nearly limitless range of configurations. Among other things, use of multiple touch-sensor matrices may enable the realization of products in different form factors, shapes, sizes, aspect ratios, etc. Regardless of the particular number and configuration of display devices, the two or more touch-sensor matrices are configured to sense touches of a finger 16 or stylus 18 (or other body parts and objects). Touch sensing occurs dynamically over a sequential progression of touch frames during which receive circuitry interprets electrical conditions existing on the touch-sensor matrices.

In the depicted example, the first display device 12 is coupled to an image source S1 and the second display device 14 is coupled to an image source S2. The image sources S1 and S2 may be an external computer(s) or onboard processor(s) and associated storage subsystem. The image sources S1 and S2 may be provided with multi-touch input from touch-sensor matrices, process the multi-touch input, and produce appropriate graphical output 20 for display on the display devices 12 and 14. In other embodiments, a single image source may be coupled to the first and second display devices 12 and 14 in the display system 11 or a single image source may be coupled to a single display device spanning two or more touch-sensor matrices. Each of the display devices 12 and 14 includes an input surface 21. A user may perform finger or stylus inputs on or near the input surface 21 that are recognized and processed using touch-sensor matrices.

FIG. 2 shows a depiction of the touch-sensing system 10 and its underlying touch-sensing architecture. The touch-sensing system 10 includes a first touch-sensor matrix 30 and a second touch-sensor matrix 32, both of which typically are arranged planarly relative to display system 11. Typically, this involves the touch-sensor matrices being arranged over, or at some depth within, the display system. Also, the tough-sensing matrices typically will be parallel (or nearly so) to the one or more display devices of the display system, though other orientations are possible. In the depicted example, the first touch-sensor matrix 30 is arranged planarly relative to the first display device 12 and the second touch-sensor matrix 32 is arranged planarly relative to the second display device 14. Again, and as indicated above, the present disclosure is applicable in general to any system with multiple different touch-sensor matrices, regardless of whether they are used in connection with a display system having a single or multiple different display devices (e.g., LCD stacks).

The first and second touch-sensor matrices 30 and 32 may be configured to sense touch or stylus inputs at or near the input surface 21 shown in FIG. 1. The touch-sensing system 10 also includes a drive subsystem 33 and a receive subsystem 36. These subsystems serve to (1) influence electrical conditions on the matrices (e.g., by driving row electrodes with voltage waveforms) and (2) respond to and interpret electrical conditions on the matrices (e.g., with various circuitry attached to column electrodes).

The drive subsystem 33 is configured to couple to rows in both the first and second touch-sensor matrices 30 and 32. As explained in more detail below, typically the drive circuitry subcomponent attached to the matrix 30 rows is different than the drive circuitry subcomponent attached to the matrix 32 rows, and/or it operates differently in certain examples. In any case, the drive subsystem is configured to scan, over the course of a “touch-sensing frame,” all of the rows of the touch-sensor matrices. On a given matrix, the scanning, or driving, typically occurs row-by-row, one row at a time. In many cases, the scanning is performed serially from the top to the bottom of the matrix, or vice versa. In some cases, rather than individual scanning of row lines, two or more rows may be driven at the same time on a given matrix, but in an overall serial manner (meaning only one row, or a relatively small number of rows, is excited at a given time). Operation of the drive subsystem and row electrodes may be variously referred to herein as “driving,” “scanning,” “stimulating,” or “exciting” the row electrodes. In each case, this refers to applying a voltage waveform or other electrical signal that induces or varies electrical conditions on the electrode being driven, stimulated, etc.

In some examples, as described in more detail below, the drive subsystem 33 is configured to serially drive rows in each of the touch-sensor matrices 30 and 32 in a differential drive manner, in which a first drive signal 34 is used for the rows in the first touch-sensor matrix 30 and a second drive signal 35 is used for the rows in the second touch-sensor matrix 32. The second drive signal 35 is different from the first drive signal 34. Row driving in general, and differential excitation in particular, will be described in greater detail below.

The receive subsystem 36 includes matrix one receive circuitry 37 and matrix two receive circuitry 38. The matrix one receive circuitry 37 is coupled to the columns of the first touch-sensor matrix 30 and the matrix two receive circuitry 38 is coupled to columns of the second touch-sensor matrix 32. In the case of differential drive, the respective receive circuitry is configured differently to account for the fact that different drive signals are used to differently influence electrical conditions on the matrices (specifically, the induced conditions on the columns of matrix one differ from those on the columns of matrix two as a result of the different drive signals).

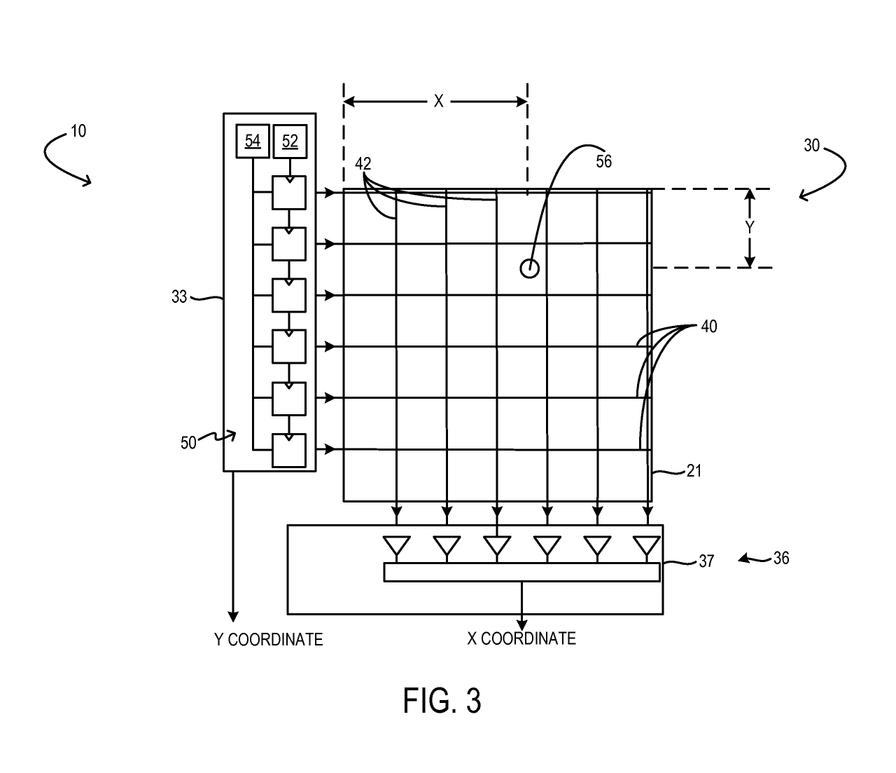

FIG. 3 shows additional aspects of the first touch-sensor matrix 30 included in the touch-sensing system 10. Although only the first touch-sensor matrix 30 is depicted it will be appreciated that the second touch-sensor matrix 32 includes similar components to those included in the first touch-sensor matrix 30 shown in FIG. 3.

Arranged on sensory surface 21 is a series of rows 40 (e.g., row electrodes) and a series of columns 42 (e.g., column electrodes). Touch screens here contemplated may include any number N of rows 40 and any number M of column 42. Further, although it is customary to have the rows 40 aligned horizontally and the columns 42 aligned vertically, this aspect is in no way necessary: indeed, the terms ‘row’ and ‘column’ may be exchanged everywhere in this description. For example, the term row and column does not denote a global orientation but rather denotes the orientation of the electrodes with respect to one another. The rows 40 in the first touch-sensor matrix 30 are sequentially electrically excited and the columns 42 in the first touch-sensor matrix 30 are scanned to pick up an incoming signal for downstream correlation operation, discussed in greater detail herein.

The drive subsystem 33 and the matrix one receive circuitry 37 are also shown in FIG. 3. Matrix one receive circuitry 37 may include M column amplifiers, each coupled to a corresponding column 42. The drive subsystem 33 may include a row counter 50 in the form of an N-bit shift register with outputs driving each of N rows 40. The row counter may be clocked by row-driver clock 52. The row counter can include a blanking input to temporarily force all output values to zero independent of the values stored. Excitation of one or many rows may be provided by filling the row counter with ones at every output to be excited, and zeroes elsewhere, and then toggling the blanking signal with the desired modulation from modulation clock 54. In the illustrated embodiment, the output voltage may take on only two values, corresponding to the one or zero held in each bit of the row counter; in other embodiments, the output voltage may take on a greater range of values, to reduce the harmonic content of the output waveforms, or to decrease radiated emissions, for example.

The description above of row counter 50 should not be construed as limiting in any way, for numerous alternative implementations are equally contemplated. For instance, the row counter may be implemented as a micro-coded state machine within a field-programmable gated array (FPGA) with the touch-sensing logic described herein. In other embodiments, the row counter may be embodied as a register within a microprocessor, or as a data structure held in computer memory associated with the microprocessor. In these and other embodiments, the row counter may take on non-negative integer values—e.g., 0, 1, . . . N.

In the depicted example, the drive subsystem 33 applies a drive signal to each row 40 in sequence. During a period in which sensory surface 21 is untouched, none of the column amplifiers registers an above-threshold output. However, when the user places a fingertip on the sensory surface, the fingertip capacitively couples one or more rows 40 intersecting the touch point 56 to one or more columns 42 also intersecting the touch point. The capacitive coupling induces an above-threshold signal from the column amplifiers associated with the column electrodes beneath (i.e., adjacent) the touch point, which provides sensing of the touch point. The matrix one receive circuitry 37 returns, as the X coordinate of the touch point, the numeric value of the column providing the greatest signal. The matrix one receive circuitry 37 also determines which row was being excited when the greatest signal was received, and returns the numeric value of that row as the Y coordinate of the touch point. In one embodiment, matrix one receive circuitry 37 may be implemented as a micro-coded state machine. However, numerous types of receive circuitry have been contemplated.

In the above description, touch inputs are identified when a given column signal goes “above threshold.” Typically this determination is made in the context of a correlation operation. In many implementations, there is a design-time determination made as to the exact character (amplitude, frequency, etc.) of a signal that will be received into the column receive circuitry in the event of a touch. In addition, predictions may be made about the likely noise that will also be received into the column receive circuitry at runtime (e.g., noise from power supply operation, operation of the LCD panel, etc.).

Being thus equipped with a fairly accurate approximation of what a touch-induced inbound signal looks like in the presence of predicted noise, the receive circuitry, in the event of an arbitrary inbound signal received at runtime, can run a correlation operation on that inbound signal, which essentially assesses the degree to which the inbound signal resembles what would be expected in the event of a finger touch. The correlation operation is “tuned” to account for the drive signal being used to excite the rows, in the sense that it typically uses a reference signal for the correlation that is based upon that drive signal (in some cases, the reference signal is identical to the drive signal). In any event, when the resemblance exceeds a threshold (i.e., the inbound signal highly correlates with what would be expected in the event of a finger touch), then the system affirmatively registers a touch occurring on that column. And as indicated above, the time at which it is received indicates the Y coordinate of the touch. It will be further appreciated that interpolation may be performed on both the X and Y coordinates to increase resolution.

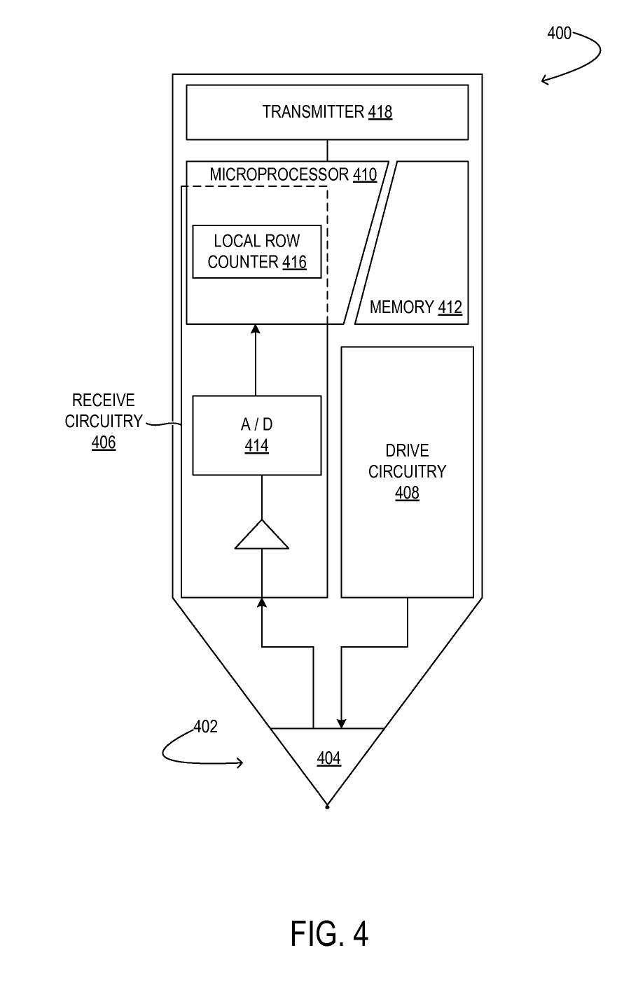

In some examples, a passive stylus having a tip of relatively high dielectric-constant material may be used in lieu of the user's fingertip to capacitively couple row and column electrodes under the touch point. A passive stylus may provide better touch accuracy than the fingertip, and may prevent smudging of the display by the fingertip. Instead of a passive stylus, however, illustrated touch-sensing system 10 may include an active stylus 400, as shown in FIG. 4 in one example embodiment.

In some examples, an active stylus may provide additional advantages. For instance, the tip portion 402 of the active stylus may be small in comparison to a fingertip or the end of a passive stylus. The smaller size of the tip portion allows the user to more precisely position the touch point on the touch screen. Moreover, the active stylus can support a faster and more accurate mode of touch sensing, as further described below.

In the depicted example, active stylus 400 includes a probe electrode 404 at tip portion 402. The probe electrode is operatively coupled to associated receive circuitry 406 and drive circuitry 408. The receive and drive circuitry 406 and 408 are operatively coupled to, and may be embodied partially within, microprocessor 410. Configured for digital signal processing (DSP), the microprocessor 410 is operatively coupled to associated computer memory 412, as described further below. The receive circuitry 406 may include linear analog componentry configured to maintain the probe electrode 404 at a constant voltage and convert any current into or out of the probe electrode 404 into a proportional current-sense voltage. The receive circuitry 406 may include an analog-to-digital (A/D) converter 414 that converts the current-sense voltage into digital data to facilitate subsequent processing. In one embodiment, the current-sense voltage may have bandwidth of approximately 100 kHz, and may be A/D-converted at a sampling rate of 1 million samples per second (MS/s). However, numerous current-sense voltages have been contemplated.

Active stylus 400 may operate in a receive mode and a drive mode. Receive mode may be employed (1) to synchronize the stylus to the computing device/processor associated with the touch-sensor matrices, to establish/maintain a shared sense of time; and (2) to establish the Y coordinate of the stylus with respect to the touch-sensor matrices (or the X coordinate in the event of vertically-oriented rows). Synchronization typically occurs at the beginning of the touch frame, in which one or more rows on the touch-sensor matrices are driven with a synchronization pulse that induce/vary electrical conditions on the tip electrode of the active stylus. The received signal is processed, typically via a correlation operation, in order to establish/maintain the shared sense of timing. In some cases, this will involve synchronization of the row counter 416 of the stylus. Usually, multiple rows, spanning the entire height/width of the touch-sensor matrices, are driven with the synchronization pulse so that the stylus receives an adequate signal regardless of its position relative to the touch-sensor matrices.

Active stylus 400 may also operate in a receive mode during normal scanning of the rows of the touch-sensor matrices. In other words, the stylus may receive signals while the rows are scanned to establish the X and Y coordinates of finger hover/touch on the touch-sensor matrices. The receive circuitry typically runs a correlation operation that is tuned to the drive signal(s) being used on the touch-sensor matrices. In the case of differential drive on the matrices, the receive circuitry of the stylus would be tuned to account for the drive signal on the first matrix, and with a second correlation operation tuned to account for the drive signal used on the second matrix. Upon receiving a signal of greatest amplitude (e.g., highest correlation), the stylus makes a note of the timing of that highest signal. This timing recordation could be performed, for example, using row counter 416. The recorded timing allows the stylus and the computing system of the touch-sensor matrices to know which row the stylus was closest to, thereby establishing the Y position of the stylus. In some examples, the stylus reports row position information (e.g., timing, value of the row counter, etc.) over some time of wireless link (e.g., using transmitter 418). Instead of or in addition to a radio link, row position information may be transmitted electrostatically via excitation of the tip electrode of the stylus. Also, interpolation will often be employed to increase positional resolution. For example, assuming a highest amplitude at row K, amplitudes may also be noted for rows K−2, K−1, K+1, K+2. Assessing the amplitudes for these neighboring rows can enable finer determinations of Y position. Essentially, the stylus “listens” for a communication from rows, and based on the “loudness” of that communication, an assessment is made as to how close the stylus is to the row that is “talking.” By assessing communication volume from a few rows on either side of the “loudest” row, a higher position granularity may be determined.

In addition to receiving during a “sync subframe” and during a “row-drive” subframe, the stylus may drive its electrode during a “stylus-drive” subframe. In this case, application of a drive signal to the stylus tip electrode influences/varies electrical conditions on one or more column electrodes of the touch-sensor matrices. The column receive circuitry correlates, as described above, in order to interpret the received signals. The column experiencing the highest signal, or an above-threshold signal, is deduced to be the column that the stylus is closest to, thereby establishing the X position of the stylus. And as with the Y determination, the conditions at a clustered grouping of columns may be used to establish a higher positional resolution.

It will also be appreciated that signals received in the stylus-drive subframe can be used to disambiguate Y-position of the stylus. In many cases, the row scan pattern used in a system with two or more touch-sensor matrices will typically involve a row on one matrix being scanned at the same time as a row on another matrix. In this case, when the stylus reports the timing of its highest received amplitude, the system cannot know which matrix the stylus was on, i.e., whether it is near the activated row of matrix one or the activated row of matrix two. During the stylus-drive subframe, the stylus will only light up columns on the matrix it was near, thereby enabling the ambiguity to be resolved.

As indicated above, in some cases it will be desirable to employ multiple touch-sensor matrices. In some cases this will allow electrode traces of the touch-sensor matrices to be shorter and therefore have lower resistance, which may be desirable in some settings. In other cases, multiple touch-sensor matrices may provide modular flexibility, and can enable construction of touch interactive devices of different sizes, shapes, aspect ratios, etc.

When using multiple touch-sensor matrices, touch-sense functionality may be coordinated in various ways. In some examples, the touch-sensor matrices are synchronized so that the row drive operations on each matrix are similarly clocked and occur at the same frequency. In other words, at the moment a row on one touch-sensor matrix starts to be energized, a row on another touch-sensor matrix starts to be energized. The rows are driven during a common edge-aligned timeslot, and at the beginning of the next shared timeslot, a new row on each matrix starts to be energized. Row scanning progresses serially in this fashion row-by-row, with the drive timeslots on each matrix being shared, in the sense that they synchronized, edge-aligned and occur at the same frequency on each matrix.

Various choices may be made with respect to the sequencing and patterning of row scan operations. As mentioned above, in single-matrix implementations, there are many options for how row scanning can occur, all of which may be used in a multiple matrix implementation. Typically, however, it will be desirable to design and drive patterns in a coordinated manner to realize various performance goals. Such goals may include avoiding duplicated or missed inputs in a touch frame; increasing stylus resolution; avoiding signal loss at matrix edges; increasing signal-to-noise ratio; among others.

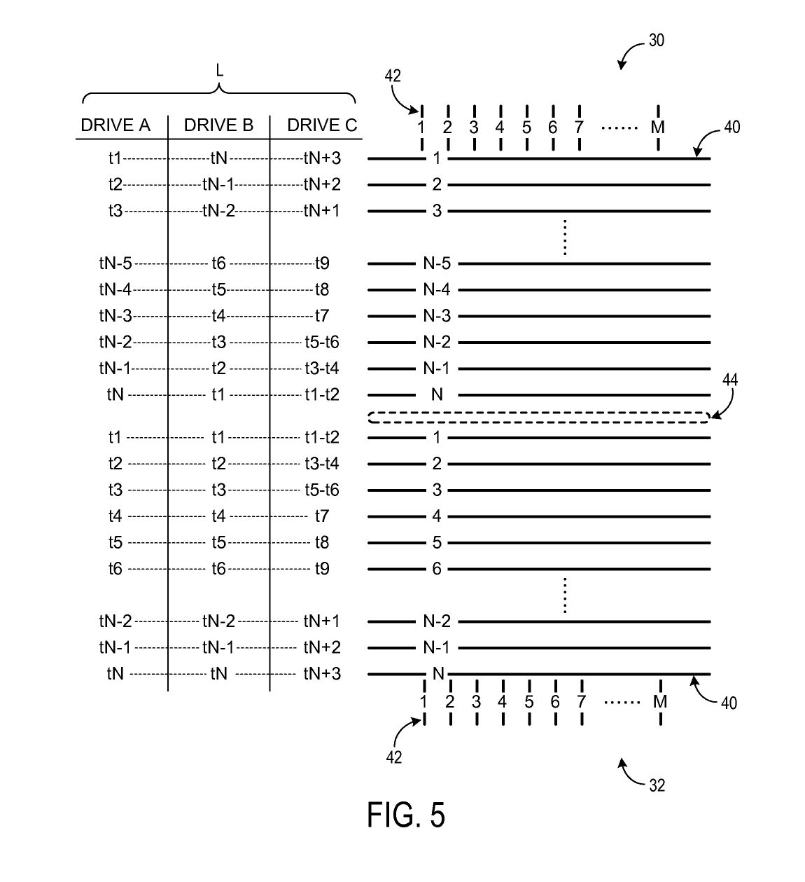

FIG. 5 depicts touch-sensor matrix 30 and touch-sensor matrix 32 in simplified form, along with a legend L to the left of the matrices showing potential example drive schemes for the rows. Each touch-sensor matrix has N rows 40 and M columns 42. The columns are only partly shown to simplify the figure. A seam 44 extends between the matrices, specifically between the edge rows (row N of touch-sensor matrix 30 and row 1 of touch-sensor matrix 32).

Though not shown in the figure, drive subsystem 33 (FIG. 2) is coupled to the rows of both matrices, and receive subsystem 36 (FIG. 2) is coupled to the columns of both matrices. With both the drive and receive circuitry, portions may be employed that are specific to each matrix in order to support differential drive and receive functionality. Specifically, drive subsystem 33 may have drive circuitry specific to matrix 30 and drive circuitry specific to matrix 32. Receive sub-system 36 may be similarly sub-allocated. FIG. 2 specifically shows such a division in receive subsystem 36, in which separate receive circuitry is present for the two different matrices. In any case, as described above, the operation of the matrices occurs over a temporal succession of touch frames, at a frame rate (e.g., 120 Hz) which may be arrived at via various constraints and performance considerations. Each touch frame may have a number of subframes, as mentioned above.

As briefly introduced above, various functionality occurs during different portions of the touch frame. In the sync subframe, in a system with an active stylus, several rows (e.g., every third row) of the matrices are driven with a synchronization signal that establishes or maintains a shared sense of time between the stylus and the computing device associated with the touch sensors. During the row-drive subframe, the drive subsystem 33 serially drives the rows of the matrices (one at a time or in small groups at a time) in order to induce/vary electrical conditions on the columns, and to induce/vary electrical conditions on the stylus tip electrode. The induced/varied conditions are interpreted by the receive subsystem 36 and by receive circuitry in the stylus in order to establish (1) X and Y position of any finger touches to the touch-sensor matrices during the touch frame; and (2) Y position of the stylus tip. In the stylus-drive subframe, the stylus tip electrode is driven to induce/vary electrical conditions on the columns of the touch-sensor matrices, and this operation is used to establish the X position of the stylus. As discussed above, the processing and interpretation in the various receive componentry is typically implemented via correlation functionality, in which received signals are assessed using a reference signal and correlation operation to evaluate the degree to which they resemble a known signal associated with an event of interest (e.g., an applied touch input). Also, interpolation may be used in connection with X and/or Y position for both finger and stylus touches (and hover detection).

Legend L indicates potential drive schemes for the rows of touch-sensor matrices 30 and 32. The drive schemes are each described in terms of successive timeslots: t1, t2, t3, etc. In many implementations, the timeslots will all be of equal duration, though different-length timeslots are possible. The different drive schemes indicate the timeslot during which the row is being driven by the drive subsystem. For example, in Drive Scheme A, row 1 of matrix 30 and row 1 of matrix 30 are driven during timeslot t1; row 2 of each matrix is driven in timeslot t2, etc.

It will thus be appreciated that Drive Scheme A is a “same-direction” scan in which rows are scanned serially in the same direction on each matrix. In this example, the rows are scanned starting at the top of the matrices and moving downward. Such a top-to-bottom scheme may be modified in various ways, for example by scanning, on a given one of the matrices, two adjacent rows at a time, or with patterns that skip over rows and then return back to them, but with a general overall movement from top-to-bottom. Another variation of this drive scheme would be to scan from the bottom to the top of the matrices.

In many environments, Drive Scheme A can provide high-frequency touch frames, minimal stylus lag, and a straightforward control regime. One potential issue involves finger movement near seam 44. If a user moves their finger with sufficient velocity back and forth across seam 44, the system may entirely miss, in a given touch frame, the presence of the user's finger, or record a duplicate input. A stylus may also cause this problem.

Drive Scheme A can also potentially compromise the operation of an active stylus. As discussed above, in some cases an active stylus records/samples in its receive circuitry a response resulting from the driving of each row in a geometrically-clustered grouping of rows (e.g., five rows, centered upon a row producing the greatest response in the stylus). Group sampling may be used, for example, to interpolate stylus position at a resolution greater than the distance between adjacent rows. In the case of a sampled cluster spanning the two touch matrices (e.g., the bottom three rows of matrix 30 and the top two rows of matrix 32), the matrix 30 measurements will happen at a significantly different time than the matrix 32 measurements if Drive Scheme A is used. Specifically, the matrix 32 measurements would happen toward the beginning of the touch frame and the matrix 30 measurements would happen toward the end of the touch frame. Within this period of time (e.g., 8.3 ms for a 120 Hz frame rate), if a stylus moves with sufficient velocity back and forth across seam 44, the system may entirely miss, in a given touch frame, the presence of the stylus, or record a duplicate input, or not be able to increase the position resolution with interpolation (e.g., Y coordinate). In an environment with time-varying noise, this introduces that possibility that the noise conditions for part of the stylus position measurements will vary significantly from the noise conditions for the remaining measurements.

In some settings, improved performance near seam 44 can be achieved with one or more modified scan patterns that cause near-seam, or near-edge rows near the edges of the matrices to be driven closer in time. An edge group of rows can include any number of matrix rows. Assume, in one example, that an edge group next to seam 44 on each matrix includes 8 rows. Therefore, the edge group on matrix 30 includes rows N−7 through N. The edge group on matrix 32 would include rows 1 through 8. Matrix 30, row N runs parallel to matrix 32, row 1. A potential drive scheme can therefore include an edge group drive interval during which all of the rows of the two edge groups are driven. In other words, during the row-drive subframe, the rows on each matrix near the seam are driven more or less at the same time (e.g., instead of one edge group being scanned at a significantly different time than the other edge group), In this case, the finger/stylus velocity required to cause missed or duplicated touches is significantly higher than with Drive Scheme A. Also, assuming the stylus being closest to row N of matrix 30, the adjoining row measurements (rows N−1 and N−2 of matrix 30, and rows 1 and 2 of matrix 32) would all occur very close in time, reducing the vulnerability of the stylus measurements to time-varying noise (i.e., because all of the row measurements for the stylus are taken at more or less the same time, the noise for each sample is roughly the same).

A more specific implementation that scans near-seam rows close in time is shown in the figure as Drive Scheme B. This scheme may be referred to as a reverse direction scheme or reverse scan pattern, in the sense that the serial row scanning progression on matrix 30 moves in a direction opposite to the scanning on matrix 32. Specifically, as indicated in legend L, matrix 30 scans from bottom to top, and matrix 32 scans from top to bottom. Both matrices scan individual rows in an unvaried sequential fashion, though other variations are possible, including scanning multiple rows together, deviations from perfect sequential scans. Regardless of the specific implementations, there is a general bottom-to-top movement (matrix 30) and top-to-bottom movement (matrix 32). It will be appreciated that the directions may be reversed, so that scanning moves inward toward seam 44 (matrix 30 scans top to bottom and 32 scans bottom to top).

In a first iteration of the Drive B Scheme, both matrices are driven with the same drive signal. Such an implementation provides a number of simplifications, and may therefore be desirable from that standpoint. In some cases, however, the stylus performance near seam 44 may degrade, for example lag may increase or there may be reduced positional resolution. As described above, stylus position may be determined by taking row measurements in which the stylus “listens” to the rows as they are driven, and interpolation to increase resolution is often accomplished by taking measurements from a number of rows on either side of the row generating the largest signal. The ability to take a measurement from a given individual row is compromised if a second, nearby row is being driven at the same time. In Drive Scheme B, (1) row N of matrix 30 and row 1 of matrix 32 are driven at the same time; (2) row N−1 of matrix 30 and row 2 of matrix 32 are driven at the same time; (3) row N−2 of matrix 30 and row 3 of matrix 32 are driven at the same time; etc. It will thus be appreciated that, when the stylus is near seam 44, its ability to measure signal/distance from any given nearby row is compromised by the fact that another nearby row is simultaneous firing.

A reverse scan drive scheme can be modified somewhat so that near-seam rows fire individually (i.e., while a near-seam row on matrix 30 fires, there are no near-seam firings on matrix 32). For example a sequence could be implemented as follows: t1(matrix 30, row N); t2(matrix 32, row 1); t3(matrix 30, row N−1); t4(matrix 32, row 2); etc. In this modification, the stylus would be able to take individual row measurements while near seam. It will be appreciated, however, that this scheme lengthens the touch frame, which can be undesirable in some settings.

In an alternate scheme, multiple near-seam rows can fire at the same time without compromising stylus performance when the two matrices are driven in a differential drive manner Specifically, the rows of matrices 30 and 32 are driven with different drive signals. In these examples, various receive subsystems (e.g., attached to the columns and/or within the stylus) are tuned to account for the drive signals being used. For example, if matrix 30 is driven with a particular drive signal, then the receive circuitry coupled to its columns may be tuned to run correlations that account for and/or are based on that drive signal. In some cases, this will involve running a correlation using a reference signal based on the drive signal, or perhaps using the drive signal itself as a reference. Typically, the correlation operation will also include an accounting for noise, which may involve filtering, tailoring of the reference signal to account for the noise, etc.

Returning to the example of a stylus tip being closest to row N of matrix 32, assume that the two matrices are being driven with different drive signals as mentioned above. Row N of matrix 30 and row 1 of matrix 32 fire at the same time, but with different drive signals. The stylus has receive circuitry tuned to run correlations on each drive signal. Therefore, the stylus, during its “listening” to the “talking” of row N of matrix 30, is not confused by the fact that row 1 of matrix 32 is “talking” at the same time. It is able to separate out the two transmitted signals and obtain individual measurements from the simultaneously firing rows due to it having the ability to separately run correlations for each drive signal. Using the above “conversation” metaphor, the stylus is able to “listen” to both drive signals.

A differential drive scheme may be implemented for a variety of reasons. In some applications, when the same drive signal is applied on both sensor matrices, the sensors may transmit/receive simultaneously. The signal from one sensor matrix may capacitively couple into the receive columns of the other matrix, for example, through the LCD. The variance of such coupled signal is an interference and may decrease the signal to noise ratio of the received signal. Such interference may be significantly reduced by using a differential drive scheme. For example, if the correlation coefficient between the differential drive signals is equal to zero, the interference may be eliminated. In one category of useful scenarios, a differential drive scheme may be implemented in scan patterns where a near-seam row on one matrix fires at the same time as a near-seam row on an adjacent matrix. Differential drive in this situation allows the stylus to operate with high precision even though multiple rows near it are firing at the same time. A somewhat more specific implementation is where the drive pattern involves a group of rows on one matrix that is near the seam, and a group of rows on another matrix that is near the seam, where all of those near-seam rows are driven close in time, for example in an interval spanned by a relatively small number of timeslots. Drive Scheme B is also a possible differential drive implementation, in which there is a straight sequential scan in opposite directions on the two matrices.

In differential drive examples, as discussed above, each matrix typically will have receive circuitry that is tuned to a different drive signal (i.e., the matrix 30 columns employ receive circuitry 37 tuned to drive signal 34 while the matrix 32 columns employ receive circuitry 38 tuned to drive signal 35). Typically, in these examples, during the stylus-drive subframe, the stylus is operable to transmit using both drive signals. Specifically, drive circuitry 408 may include circuitry for driving with drive signal 34 and with drive signal 35. This allows, particularly in implementations where the receive circuitry on each matrix is tuned only to its own drive signal, for accurate X position resolution of the stylus. In this regard, it will be noted that the stylus-drive subframe may be important in implementations where a row or rows on one matrix is firing at the same time as a row or rows on another matrix. If the stylus receives high correlation signals in a given interval, it may not be known whether the stylus was near the firing row(s) on the first matrix or the second matrix. However, during the stylus drive subframe, only one of the matrices will have columns that light up. And this allows the ambiguity to be resolved. In some examples, as discussed herein, it may be desirable to have the receive circuitry in each matrix be tuned to correlate against the drive signal used on the other matrix. In this case, it may be possible to have the active stylus use only one drive signal, which can potentially simplify the stylus components, reduce power usage, etc.

In differential drive examples, the drive signal on a given matrix may differ from that used on an adjacent matrix in a variety of ways. At a general level, the drive signals may differ in any way that permits their contributions to electrode conditions to be distinguished from one another. In other words, if both drive signals are contributing to charge, voltage, capacitance, current etc., the signals may vary in any non-trivial way provided that receive circuitry can be constructed to extract and measure, to an acceptable level of accuracy, the contributions caused by a given one of the drive signals and filter out contributions caused by other drive signals. Signal differentiation may be in terms of frequency, amplitude, phase or any other appropriate characteristic. In some cases, the differential drive signals may be designed such that their correlation coefficient is equal to zero (e.g., generating differential signals via frequency division multiple access (FDMA) and/or code division multiple access (CDMA)). In some cases, since it may be not possible to design signals that are perfectly orthogonal to each other under the design constraints (e.g., slot time, frequency response), differences may be conceived in terms of the signals being orthogonal to some degree. For example, different pseudo noise (PN) codes with ideal frequency response may be applied on different sensor matrices, while their correlation coefficient may be close, but not equal, to zero (e.g., the absolute value of the correlation coefficient is less than 0.2 will often be acceptable).

In a variety of different multiple matrix settings, performance may vary near seams between matrices. This area is often unshielded or provides only limited shielding. As a result, some portion of the effect produced by the driving of a near-seam row goes to affecting column conditions on the adjoining matrix. Referring to matrices 30 and 32 of FIG. 5, a simplistic characterization is as follows: when row N of matrix 30 fires, 75% of its signal power goes to affecting conditions on the columns of matrix 30, while the remaining 25% goes to affecting column conditions on matrix 32. The column receive circuitry of matrix 30 therefore receives a signal that is weaker than would be the case for a row farther away from the seam.

In many cases, it will be desirable to address the above by using receive circuitry on the adjoining matrix to “recapture” the “lost” signal. Specifically, to the extent that the receive circuitry on a matrix can discern that an inbound signal or portion of an inbound signal is caused by near-seam row excitation on an adjoining matrix, the identified signal or signal portion can be passed to the other matrix for summing within that matrix's receive circuitry. Then, instead of receiving only 75% of a signal in its receive circuitry, 100% is received due to recapture at the adjoining matrix.

To enable signal recapture in a differential drive scheme, the receive circuitry for each matrix may be tuned to run correlations on both its own drive signal, and on the drive signal for the adjoining matrix. Assuming a Matrix One Drive Signal for matrix 30 and a Matrix Two Drive Signal for matrix 32, each matrix includes receive circuitry configured to run correlations on each drive signal. If we then imagine that row N of matrix is driven with the Matrix One Drive Signal and row 1 of matrix 32 is simultaneously driven with the Matrix Two Drive Signal, both of the row excitation will partly couple on to the other matrix. Specifically, the energy from the row N, matrix 30 excitation will partly couple onto the columns of matrix 32, and the energy from the row 1, matrix 32 excitation will partly couple onto the columns of matrix 30. The cross-matrix coupling onto matrix 32 will be from the Matrix One Drive Signal. Since the matrix 32 receive circuitry is tuned to run correlations on the other matrix's drive signal, matrix 32 is able to “hear and recapture” the signal from neighboring matrix 30. In other words, each matrix is capable of running a drive signal correlation on the other matrix's drive signal. When such a correlation realizes an output induced as a result of electrical excitation of one or more rows on the other matrix with the other matrix's drive signal, that output is providing for summing to the other matrix's receive circuitry.

In some settings, the above-described recapture allows for roughly full-power recapture of signal but with a greater noise contribution due to bringing in noise from multiple touch-sensor matrices. Drive Scheme C may therefore be used, in which longer integration times are used for near-seam rows. Specifically, as shown in the figure, the three rows on each matrix that are nearest seam 44 are driven and integrated for two timeslots. This time-doubling scheme is but an example implementation; the method generally encompasses driving any number of near-seam rows longer than rows further from the seam in order to reduce SNR via longer integration times.

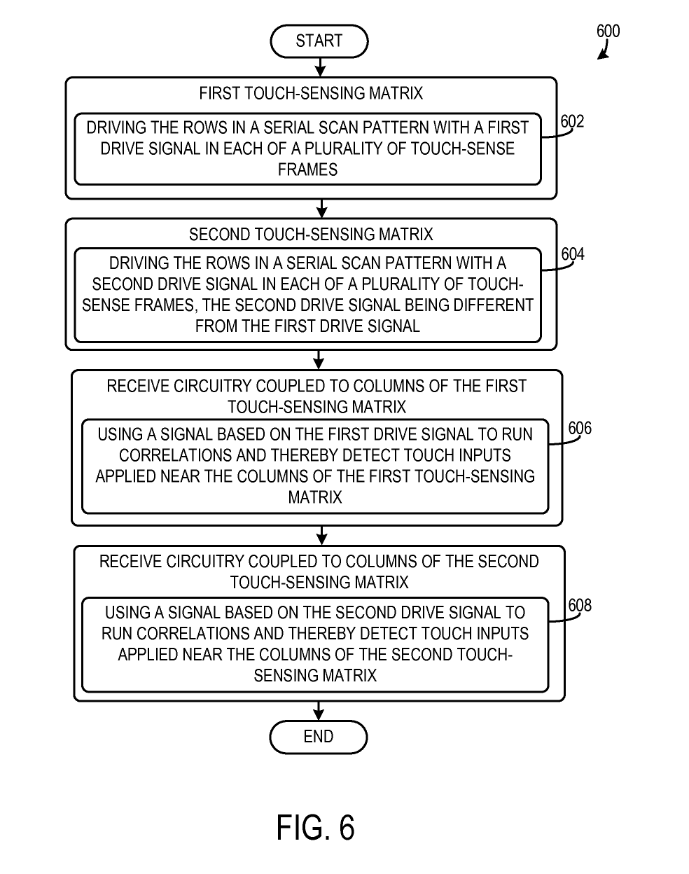

FIG. 6 shows a method 600 for operating a touch-sensing system for use with a display system. The method 600 may be implemented via the touch-sensing system 10 and corresponding subsystem, components, etc., described above with regard to FIGS. 1-5 or may be implemented by another suitable touch-sensing system.

At 602, the method includes, at a first touch-sensor matrix having rows and columns and situated planarly relative to the display system, driving the rows in a serial scan pattern with a first drive signal in each of a plurality of touch-sense frames. At 604, the method includes, at a second touch-sensor matrix having rows and columns and situated planarly relative to the display system, driving the rows in a serial scan pattern with a second drive signal in each of a plurality of touch-sense frames, the second drive signal being different from the first drive signal. As previously discussed, the first drive signal and the second drive signal may be at least partially orthogonal to each other (e.g., time division multiple access (TDMA), frequency division multiple access (FDMA), code division multiple access (CDMA)). More generally, as described above, the drive signals may differ in any appropriate way that permits construction of receive circuitry on each matrix which is capable of discerning, to an acceptable level of accuracy, electrode effects caused by the respective drive signal.

At 606, the method includes, at receive circuitry coupled to the columns of the first touch-sensor matrix, using a signal based on the first drive signal to run correlations and thereby detect touch inputs applied near the columns of the first touch-sensor matrix. At 608, the method includes, at receive circuitry coupled to the columns of the second touch-sensor matrix, using a signal based on the second drive signal to run correlations and thereby detect touch inputs applied near the columns of the second touch-sensor matrix. In this way, correlations taking into account the first and second drive signals can be implemented via the receive subsystem to accurately determine touch and stylus inputs without performance deficits occurring near the seam between the matrices. The receive circuitry for each matrix may be configured to correlate not only on its own drive signal, but also on the drive signal used for rows of the other matrix. In such examples, the receive circuitry for a given column that is tuned to the other matrix's drive signal may be configured, for electrical conditions induced on its column electrode, to discern contributions resulting from row drive on the other matrix using the other matrix's drive signal, and then return those contributions to the other matrix for summing. In such summing examples, it may be desirable to increase integration times at near-seam rows to increase SNR.

The method of FIG. 6 may also make use of an active stylus that operates as describe above. Namely, such a stylus may acquire sync during a sync subframe via the use of receive circuitry responsive to electrical conditions on a stylus tip electrode, the electrical conditions being induced/varied as a result of drive signals applied to the rows of the matrices. During the row-drive subframe, the receive circuitry runs correlations to interpret signals on its electrode and use those interpretations in collaboration with the host device to establish an interpolated Y position of the stylus. During a stylus drive subframe, the stylus electrode is stimulated to induce/vary conditions on the column electrodes of the touch-sensor matrices. In some examples, the receive circuitry in the stylus is tuned to run correlations on both of the two different drives signals used for the matrices. In some examples, the stylus transmit circuitry used during stylus-drive is configured to transmit both of the drive signals.

In some embodiments, the methods and processes described herein may be tied to a computing system of one or more computing devices. In particular, such methods and processes may be implemented as a computer-application program or service, an application-programming interface (API), a library, and/or other computer-program product.

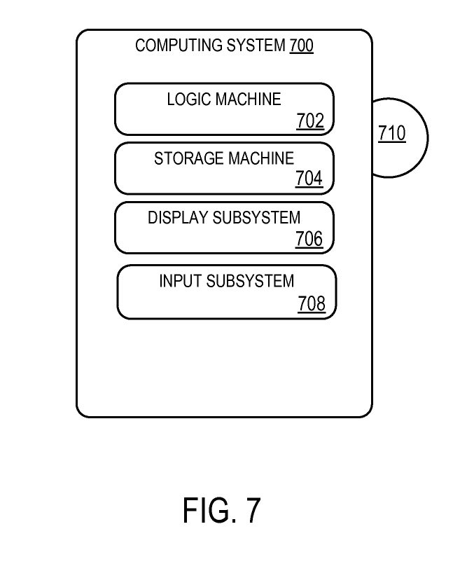

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

With specific reference to FIGS. 1 and 2, mechanisms similar in various respects to logic machine 702 and storage machine 704 may be implemented in a way so as to control operation of the touch-sensing examples discussed above. For example, one or more controllers (logic machines) may execute hardware and/or software instructions to control the application and timing of drive signals applied to rows of touch-sensor matrices 30 and 32. One or more logic/storage machines may generate correlation reference signals; run correlation operations; execute instructions to filter and otherwise compensate for noise; etc.

The terms “module,” “program,” and “engine” may be used to describe an aspect of computing system 700 implemented to perform a particular function. In some cases, a module, program, or engine may be instantiated via logic machine 702 executing instructions held by storage machine 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 (e.g., the display devices of FIGS. 1 and 2) may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

In a first example, this description provides for a touch-sensing system. The touch-sensing system may include (1) a first touch-sensor having first rows and first columns; (2) a second touch-sensor having second rows and second columns, the second touch-sensor proximate to the first touch-sensor; and (3) a drive circuit coupled to the first rows and to the second rows. In these examples, within each of a plurality of touch-sense frames, the drive circuit may be configured to serially drive the first rows and the second rows in a differential drive manner, in which a first drive signal is used for the first rows and a second drive signal, different from the first drive signal, is used for the second rows.

In some implementations of the first example, frequency division multiple access is performed to generate differential drive signals, where the first drive signal and the second drive signal have distinct frequency components, which are at least partially orthogonal to each other. In other implementations of the first example, code division multiple access is performed to generate differential drive signals, where the first drive signal and the second drive signal comprises distinct codes, which are at least partially orthogonal to each other.

In some implementations of the first example, the touch-sensing system may further include a receive subsystem coupled to the first columns and to the second columns, including matrix one receive circuitry coupled to the first columns and tuned to run correlations on signals effected by the first drive signal, and matrix two receive circuitry coupled to the second columns and tuned to run correlations on signals effected by the second drive signal. Further, the matrix one receive circuitry may be tuned to run correlations on signals effected by the second drive signal, and the matrix two receive circuitry may be tuned to run correlations on signals effected by the first drive signal. Still further, the receive subsystem may be configured such that, (1) when the matrix one receive circuitry, as a result of running a second drive signal correlation, realizes an output induced as a result of the electrical excitation of one or more of the second rows with the second drive signal, such output is provided for summing to the matrix two receive circuitry; and may also be configured such that (2) when the matrix two receive circuitry, as a result of running a first drive signal correlation, realizes an output induced as a result of the electrical excitation of one or more of the first rows with the first drive signal, such output is provided for summing to the matrix one receive circuitry.

In some implementations of the first example, the first touch-sensor and the second touch-sensor are next to one another with an edge row of the first touch-sensor running parallel to an edge row of the second touch-sensor, the first touch-sensor including an edge group of rows and the second touch-sensor including an edge group of rows, where each of the touch-sense frames includes an edge group drive interval during which both the edge group rows of the first touch-sensor and the second touch-sensor are driven.

In some implementations of the first example, the drive circuit is configured to drive the first rows and the second rows in a reverse scan pattern.

In some implementations of the first example, an active stylus is further included, which may have receive circuitry tuned to run correlations on signals effected by the first drive signal, and tuned to run correlations on signals effected by the second drive signal. In these implementations, the active stylus may include drive circuitry configured to send position information to a receive subsystem coupled to the first columns and to the second columns.

In a second example, a method of operating a touch-sensing system for use with a display system is provided. The method may include (1) at a first touch-sensor matrix having rows and columns and situated planarly relative to the display system, driving the rows in a serial scan pattern with a first drive signal in each of a plurality of touch-sense frames; and (2) at a second touch-sensor matrix having rows and columns and situated planarly relative to the display system, driving the rows in a serial scan pattern with a second drive signal in each of a plurality of touch-sense frames, the second drive signal being different from the first drive signal.

In some implementations of the second example, frequency division multiple access is performed to generate differential drive signals, where the first drive signal and the second drive signal have distinct frequency components, which are at least partially orthogonal to each other.

In some implementations of the second example, code division multiple access is performed to generate differential drive signals, where the first drive signal and the second drive signal comprise distinct codes, which are at least partially orthogonal to each other.

In some implementations of the second example, the method further comprises: (1) at receive circuitry coupled to the columns of the first touch-sensor matrix, using a signal based on the first drive signal to run correlations and thereby detect touch inputs applied near the columns of the first touch-sensor matrix, and (2) at receive circuitry coupled to the columns of the second touch-sensor matrix, using a signal based on the second drive signal to run correlations and thereby detect touch inputs applied near the columns of the second touch-sensor matrix.

In a third example, a system is provided. The system may have: (1) a display; (2) a first touch-sensor having first rows and first columns, the first touch-sensor configured to be situated planarly relative to the display; (3) a second touch-sensor having second rows and second columns, the second touch-sensor configured to be situated planarly relative to the display; (4) a drive circuit coupled to the first rows and to the second rows, where, within each of a plurality of touch-sense frames, the drive circuit is configured to serially excite the first rows with a first drive signal and the second rows with a second drive signal different from the first drive signal; and (5) a receive circuit coupled to the first columns and to the second columns, the receive circuit configured to perform correlations on signals effected by the first drive signal, and to perform correlations on signals effected by the second drive signal. In this example, the first touch-sensor matrix and the second touch-sensor matrix are next to one another with an edge row of the first touch-sensor matrix running parallel to an edge row of the second touch-sensor matrix, the first touch-sensor matrix including an edge group of rows and the second touch-sensor matrix including an edge group of rows, wherein each of the touch-sense frames includes an edge group drive interval during which both the edge group rows of the first touch-sensor matrix and the second touch-sensor matrix are driven.

In some implementations of the third example, the first drive signal and the second drive signal are generated via frequency division multiple access and have distinct frequency components which are at least partially orthogonal to each other. In some implementations of the third example, the first drive signal and the second drive signal are generated via code division multiple access with distinct codes that are at least partially orthogonal to each other. In some implementations of the third example, the system includes an active stylus including receive circuitry tuned to run correlations on signals effected by the first drive signal, and tuned to run correlations on signals effected by the second drive signal.

In some implementations of the third example, the receive circuit includes matrix one receive circuitry coupled to the first columns and matrix two receive circuitry coupled to the second columns, and is configured such that, (1) when the matrix one receive circuitry, as a result of running a second drive signal correlation, realizes an output induced as a result of the electrical excitation of one or more of the second rows with the second drive signal, such output is provided for summing to the matrix two receive circuitry; and (2) when the matrix two receive circuitry, as a result of running a first drive signal correlation, realizes an output induced as a result of the electrical excitation of one or more of the first rows with the first drive signal, such output is provided for summing to the matrix one receive circuitry. In these implementations, for each of the first touch-sensor and the second touch-sensor, the touch-sensor may include a group of rows at the edge of the matrix near a seam between the first touch-sensor and the second touch-sensor, and where each row in the group is driven longer than other rows of the touch-sensor.

In some implementations of the third example, the receive circuit includes: (1) a first subcircuit coupled to the first columns, the first subcircuit to perform the correlations on signals effected by the first drive signal; and (2) a second subcircuit couple to the second columns to perform correlations on signals effected by the second drive signal.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A touch-sensing system, comprising:
a first touch-sensor having first rows and first columns;
a second touch-sensor having second rows and second columns, the second touch-sensor proximate to the first touch-sensor; and
a drive circuit coupled to the first rows and to the second rows;
where within each of a plurality of touch-sense frames, the drive circuit is configured to serially drive the first rows and the second rows in a differential drive manner, in which a first drive signal is used for the first rows and a second drive signal, different from the first drive signal, is used for the second rows.

2. The touch-sensing system of claim 1, where frequency division multiple access is performed to generate differential drive signals, where the first drive signal and the second drive signal have distinct frequency components, which are at least partially orthogonal to each other.

3. The touch-sensing system of claim 1, where code division multiple access is performed to generate differential drive signals, where the first drive signal and the second drive signal comprises distinct codes, which are at least partially orthogonal to each other.

4. The touch-sensing system of claim 1, further comprising a receive subsystem coupled to the first columns and to the second columns, including matrix one receive circuitry coupled to the first columns and tuned to run correlations on signals effected by the first drive signal, and matrix two receive circuitry coupled to the second columns and tuned to run correlations on signals effected by the second drive signal.

5. The touch-sensing system of claim 4, where the matrix one receive circuitry is tuned to run correlations on signals effected by the second drive signal, and where the matrix two receive circuitry is tuned to run correlations on signals effected by the first drive signal.

6. The touch-sensing system of claim 5, where the receive subsystem is configured such that, (1) when the matrix one receive circuitry, as a result of running a second drive signal correlation, realizes an output induced as a result of the electrical excitation of one or more of the second rows with the second drive signal, such output is provided for summing to the matrix two receive circuitry; and (2) when the matrix two receive circuitry, as a result of running a first drive signal correlation, realizes an output induced as a result of the electrical excitation of one or more of the first rows with the first drive signal, such output is provided for summing to the matrix one receive circuitry.

7. The touch-sensing system of claim 1, where the first touch-sensor and the second touch-sensor are next to one another with an edge row of the first touch-sensor running parallel to an edge row of the second touch-sensor, the first touch-sensor including an edge group of rows and the second touch-sensor including an edge group of rows, where each of the touch-sense frames includes an edge group drive interval during which both the edge group rows of the first touch-sensor and the second touch-sensor are driven.

8. The touch-sensing system of claim 1, where the drive circuit is configured to drive the first rows and the second rows in a reverse scan pattern.

9. The touch-sensing system of claim 1, further comprising an active stylus including receive circuitry tuned to run correlations on signals effected by the first drive signal, and tuned to run correlations on signals effected by the second drive signal.

10. The touch-sensing system of claim 9, where the active stylus includes drive circuitry configured to send position information to a receive subsystem coupled to the first columns and to the second columns.

11. A method of operating a touch-sensing system for use with a display system, comprising:
at a first touch-sensor matrix having rows and columns and situated planarly relative to the display system, driving the rows in a serial scan pattern with a first drive signal in each of a plurality of touch-sense frames; and
at a second touch-sensor matrix having rows and columns and situated planarly relative to the display system, driving the rows in a serial scan pattern with a second drive signal in each of a plurality of touch-sense frames, the second drive signal being different from the first drive signal.

12. The method of claim 11, further comprising performing frequency division multiple access to generate differential drive signals, where the first drive signal and the second drive signal have distinct frequency components, which are at least partially orthogonal to each other.

13. The method of claim 11, further comprising performing code division multiple access to generate differential drive signals, where the first drive signal and the second drive signal comprise distinct codes, which are at least partially orthogonal to each other.

14. The method of claim 11, further comprising, (1) at receive circuitry coupled to the columns of the first touch-sensor matrix, using a signal based on the first drive signal to run correlations and thereby detect touch inputs applied near the columns of the first touch-sensor matrix, and (2) at receive circuitry coupled to the columns of the second touch-sensor matrix, using a signal based on the second drive signal to run correlations and thereby detect touch inputs applied near the columns of the second touch-sensor matrix.

15. A system, comprising:
a display;
a first touch-sensor having first rows and first columns, the first touch-sensor configured to be situated planarly relative to the display;
a second touch-sensor having second rows and second columns, the second touch-sensor configured to be situated planarly relative to the display;
a drive circuit coupled to the first rows and to the second rows;
wherein, within each of a plurality of touch-sense frames, the drive circuit is configured to serially excite the first rows with a first drive signal and the second rows with a second drive signal different from the first drive signal;
a receive circuit coupled to the first columns and to the second columns, the receive circuit configured to perform correlations on signals effected by the first drive signal, and to perform correlations on signals effected by the second drive signal; and
wherein the first touch-sensor matrix and the second touch-sensor matrix are next to one another with an edge row of the first touch-sensor matrix running parallel to an edge row of the second touch-sensor matrix, the first touch-sensor matrix including an edge group of rows and the second touch-sensor matrix including an edge group of rows, wherein each of the touch-sense frames includes an edge group drive interval during which both the edge group rows of the first touch-sensor matrix and the second touch-sensor matrix are driven.

16. The system of claim 15, where the first drive signal and the second drive signal are generated via frequency division multiple access and have distinct frequency components which are at least partially orthogonal to each other.

17. The system of claim 15, where the first drive signal and the second drive signal are generated via code division multiple access with distinct codes that are at least partially orthogonal to each other.

18. The system of claim 15, further comprising an active stylus including receive circuitry tuned to run correlations on signals effected by the first drive signal, and tuned to run correlations on signals effected by the second drive signal.

19. The system of claim 15, where the receive circuit includes matrix one receive circuitry coupled to the first columns and matrix two receive circuitry coupled to the second columns, and is configured such that, (1) when the matrix one receive circuitry, as a result of running a second drive signal correlation, realizes an output induced as a result of the electrical excitation of one or more of the second rows with the second drive signal, such output is provided for summing to the matrix two receive circuitry; and (2) when the matrix two receive circuitry, as a result of running a first drive signal correlation, realizes an output induced as a result of the electrical excitation of one or more of the first rows with the first drive signal, such output is provided for summing to the matrix one receive circuitry.

20. The system of claim 19, where, for each of the first touch-sensor and the second touch-sensor, the touch-sensor includes a group of rows at the edge of the matrix near a seam between the first touch-sensor and the second touch-sensor, and where each row in the group is driven longer than other rows of the touch-sensor.

21. The system of claim 15, wherein the receive circuit comprises:
a first subcircuit coupled to the first columns, the first subcircuit to perform the correlations on signals effected by the first drive signal; and
a second subcircuit couple to the second columns to perform correlations on signals effected by the second drive signal.
